(19) United States
(12) Patent Application Publication
(10) Pub. No.: US 2014/0370421 A1
(43) Pub. Date: Dec. 18, 2014

(54) HYDROGEN OXIDATION REACTION RATE BY PROMOTION OF HYDROXYL ADSORPTION

(71) Applicant: UChicago Argonne, LLC, Chicago, IL (US)

(72) Inventors: Dusan Strmcnik, Woodridge, IL (US); Vojislav Stamenkovic, Naperville, IL (US); Nenad Markovic, Hinsdale, IL (US)

(21) Appl. No.: 13/920,714

(22) Filed: Jun. 18, 2013

(51) Int. Cl. H01M 4/92; H01M 4/88

(52) U.S. Cl. CPC H01M 4/921; H01M 4/8825
USPC 429/524; 502/100; 502/339; 502/326; 502/101; 429/523; 429/526; 429/525

(57) ABSTRACT

A method and article of manufacture including a catalytic substrate with a surface layer providing balanced active sites for adsorption/dissociation of H₂ and adsorption of OH_{ad} for use in AFCs.

### STATEMENT OF GOVERNMENT INTEREST

The U.S. Government claims certain rights in this invention pursuant to Contract No. DE-AC02-06CH11357 between the U.S. Department of Energy and UChicago Argonne, LLC, representing Argonne National Laboratory.

### FIELD OF THE INVENTION

This invention is directed to an improved catalyst and method of manufacture by establishing active catalytic sites for balanced adsorption of OH_{ad} and H_{ad}. More particularly the invention is directed to an improved hydrogen oxidation reaction catalyst for alkaline fuel cells by forming oxophylic sites on metals, such as but not limited to, Ir (defects), Pt—Ru (Ru atoms) and 3d metal hydroxide decorated Pt (M(OH)ₓ clusters) based electrodes to establish OH_{ad} being adsorbed which react with H intermediates adsorbed on more noble metal surface sites.

### BACKGROUND OF THE INVENTION

This section is intended to provide a background or context to the invention that is, inter alia, recited in the claims. The description herein may include concepts that could be pursued, but are not necessarily ones that have been previously conceived or pursued. Therefore, unless otherwise indicated herein, what is described in this section is not prior art to the description of claims in this application and is not admitted to be prior art by inclusion in this section.

The ever-growing need for new clean energy sources and also the concerns about global warming and energy security are demanding the expansion of renewable energy sources as viable alternatives to fossil fuel based technologies. In most commercially viable sources, hydrogen is the desired energy carrier; and despite several hurdles that still need to be overcome, hydrogen appears to be the most promising fuel of the future. The two key reactions governing the hydrogen economy are the hydrogen oxidation reaction (hereinafter “HOR”) and the hydrogen evolution reaction (hereinafter “HER”) in aqueous environments. The former reaction mostly finds applications in fuel cells and the latter in various electrolyzers. The HER/HOR reactions in acid environments are: (2H⁺+2e⁻⇄H₂) and in alkaline environments, (2H₂O+2e⁻⇄H₂+2OH⁻). These also are electrochemical reactions of fundamental importance since the basic laws of electrocatalysis were developed and verified by examining these two reactions. So far, a large number of experimental and theoretical methods have been applied to help understand the reaction mechanisms of the hydrogen reaction in acid electrolytes. The intrinsic kinetic rates, defined as the rate at which a reaction proceeds at the equilibrium potential (zero net current), varies by several orders of magnitude depending on electrode material. These variations in activities are closely related to the variations in the hydrogen adsorption free energies from one material to the next, with the highest rates observed on Pt-based materials with an optimal interaction of H_{ad} with the catalyst surface (around zero free energy of adsorption).

Much less work has been directed towards understanding hydrogen production and hydrogen oxidation reactions in alkaline solutions, although these two processes are of paramount importance for the development of alkaline electrolyzers and alkaline fuel cell (hereinafter “AFC”) systems. Traditionally, the differences in the kinetic rates of the HER/HOR reactions on various electrode materials in alkaline environments have also been linked to variations in the hydrogen adsorption energy. While this supposition is thermodynamically viable, it is still not understood why the HER/HOR activities are 2-3 times higher in acid than in alkaline electrolytes, or why the reactions are more sensitive to the catalysts' surface structure in alkaline media than in acids. Consequently, there is a substantial need for developing new methods and articles of manufacture for use in alkaline environments of AFCs. Such technology for AFC applications would provide a highly advantageous source for energy production. AFCs have the highest electrical production efficiency at 60% according to a 2008 DOE report and such AFCs operate at low temperatures of about 60°-100° and thus do not have “hot spots” as in PEMS. Also since such AFC systems would not use a highly acidic electrolyte, much less costly materials can be used. Therefore, it is highly desirable to improve catalytic activity for AFCs.

### SUMMARY OF THE INVENTION

A family of bifunctional catalysts (simultaneous H_{ad} and OH_{ad adsorption} on a catalyst) have been identified which provide greatly enhanced activity in alkaline fuel cells by control of both the substrate-H₂/H_{ad} and the substrate-OH_{ad} energetics. The most active materials employ (1) a nano based catalytic noble metal material such as Ir, and other like functioning metals (such as Rh) which have a more oxophylic activity than Pt (a stronger interaction with OH_{ad}, but with about the same binding energy with H_{ad}); (2) bimetallic materials which provide simultaneously active sites for dissociative adsorption of H₂ and adsorption of OH_{ad}, such as Pt combined with Ni(OH)₂ ad-islands or other transition metal hydroxi-oxides with the transition metal selected from the d-block of the periodic table; (3) alloys of Pt with more oxophylic elements, such as Ru, Os, Re, Ir, Rh and (4) selected annealed of alloys with modified surface composition. The resulting catalysts are dramatically more active in HOR for alkaline fuel cell environments then pure Pt. Such systems not only offer much higher activity, but also enable use of much lower cost materials than Pt. These advantageous materials and methods can be successfully implemented into commercial anode nano-catalysts for the AFCs.

Various aspects of the invention are described hereinafter; and these and other objects of improvements are described in detail hereinafter, including the drawings described in the following section.

### BRIEF DESCRIPTION OF THE DRAWINGS

FIGS. 1a-1f illustrate determination of the role of OH on the HOR in alkaline solution with comparison of current voltage behavior versus a standard hydrogen electrode (“SHE”) scale which for H⁺/H₂ couple is defined by E^{o}-0.0V and pH dependent current-potential polarization curves are taken at rates of 1600 rpm and a sweep rate of 50 mV/s and FIG. 1a is for Au (111), FIG. 1b is for Pt(111), FIG. 1c is for Ir-pdy and situated current-potential polarization curves are for HER/HOR; FIG. 1d is for gold type electrode (K_{1 anodic}=0, K_{2 anodic}=0 and K_{3 cathodic}=10⁻⁹ and K_{2 cathodic}=10⁻⁶; and FIG. 1e, is for Pt-type electrode (K₁=10⁻⁴, K₂=10⁻³) and FIG. 1f is for an Ir-type electrode (K₁=K₂−1);

FIGS. 2a-2f illustrate determination of the role of OH_{ad}-M energetics on rate of HOR in alkaline solutions with FIG. 2a for a HOR polarization curve at 1 mV/s (dark full line) and voltammetric response (dashed gray line and line “r”) at 50 mV/s on a Ru (0001) surface; (Note for FIGS. 2a-2f a dashed horizontal line indicate zero current). FIG. 2b is an HOR polization curve (dark full line) and voltammetry (dashed line and “r”) both at 50 mV/s on a Pt (111) surface; FIG. 2c is an HOR curve at 1 mV/s (dark line) and voltammetric response (dashed line and “r”) at 50 mV/s on Au (111) wherein 1 mV/s sweeps were used for the HOR to minimize pseudo capacitive contributions from cyclic voltammograms and CVs measured at 50 mV/s to clearly define adsorption processes occurring in a potential region of interest; FIG. 2d for HOR polization curve (dark full line) and voltammetry (dashed line and “r”) both at 50 mV/s on Ir (111) with HOR on Pt (111) shown as a comparison (dashed “g” line); FIG. 2e is for a comparison of HOR reaction rates on Pt and Ir poly surfaces; FIG. 2f is a comparison of HOR reaction rates on Pt and Ir 3-4 nm high surface area catalysts with loading for both catalysts of about 8 μg/cm²; FIG. 2g is a TEM image for a Pt nanoparticle catalyst and FIG. 2h is a TEM image for Ir nanoparticle catalyst, all data characteristic of being performed at 0.1 M KOH, a rotation rate of 1600 rpm for polarization curve measurements and reported versus RHE;

FIG. 3a(1) shows HOR/HER polization curves for Pt (111) and a dark full line and Pt (111) modified with Ni(OH)₂ ad-islands with coverage of about 20% (dashed line and “r”); FIG. 3b shows HOR/HER polization curves for Pt poly (dark line “b”) and Pt Ru alloys with 50% Ru (dashed “grey” line) and 90% Ru (dashed “r” line) and the dashed “g” line representing the HOR/HER measured on Ir predicted from simulations; note FIG. 3a(2) illustrates a bi-functional mode, Pt providing sites for H dissociation white more oxophilic Ni(OH)₂ or Ru serving as sites for formation of OH_{ad} which reacts with H_{ad} to produce water and the inset of FIG. 3b shows kinetic currents at 0.05V obtained from the Koutecky-Levich equation;

FIG. 4 illustrates a cyclic voltammogram for a Au(111) electrode in 0.1M KOH with a notable charge increase above 0.6V related to lifting of reconstruction and a sharp peak at 1.3V related to true oxide formation;

FIG. 5 shows HOR polarization curves on Ir (111), Pt (100) and Pt (111) electrodes; note that the activity of Pt (100) depends strongly on the prehistory of the electrode, and while the as prepared Pt (100) electrode is more active than Pt (111), the same electrode becomes much less active upon cycling;

FIG. 6 shows effect of ad-islands (low co-ordinated Pt atoms) on the surface of Pt (111) on the observed HOR activities, note the presence of such oxo-philic groups promotes the adsorption of OH species as a result of which the HOR is activated at potentials much closer to the reversible 0 values; and

FIG. 7 shows CO displacement results on Ir (111) at two potentials: 0.085 V and 0.385 V vs. RHE; a negatively charged species is leaving the surface at potentials just positive of the anodic peak observed in voltammetry indicating that the species is indeed OH_{ad}, and the charge density under the “b” curve was measured to be 110 μC/cm².

### DETAILED DESCRIPTION OF PREFERRED EMBODIMENTS

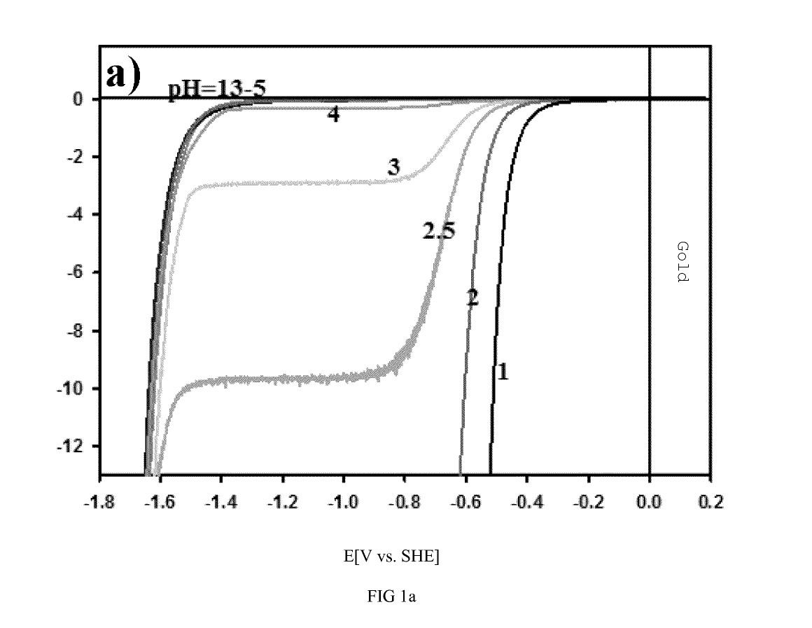

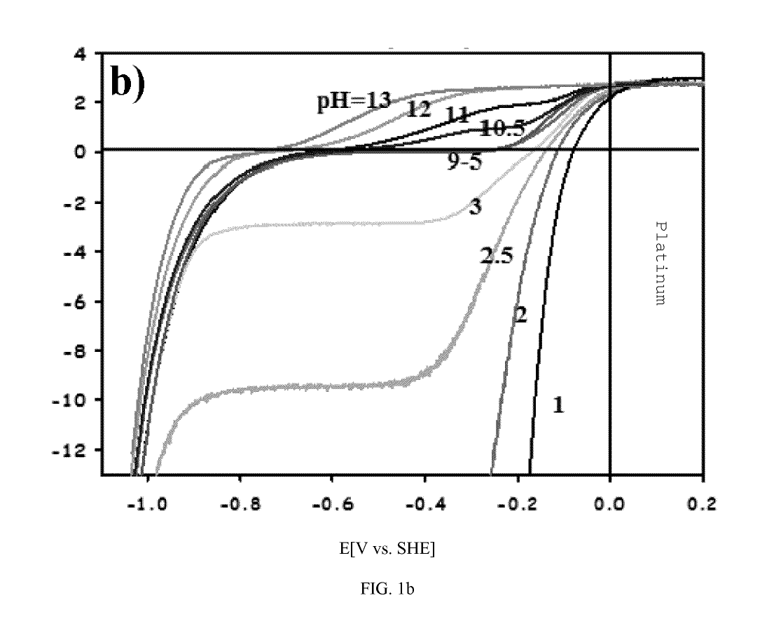

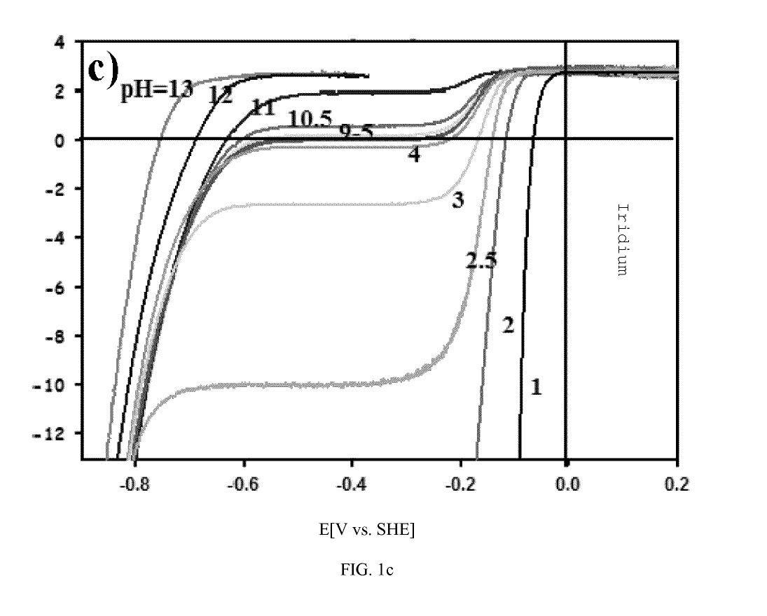

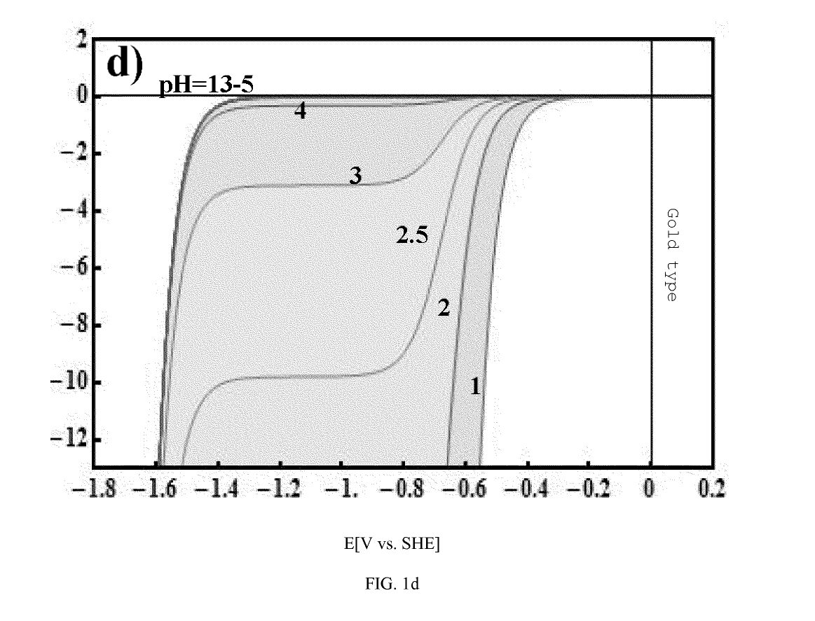

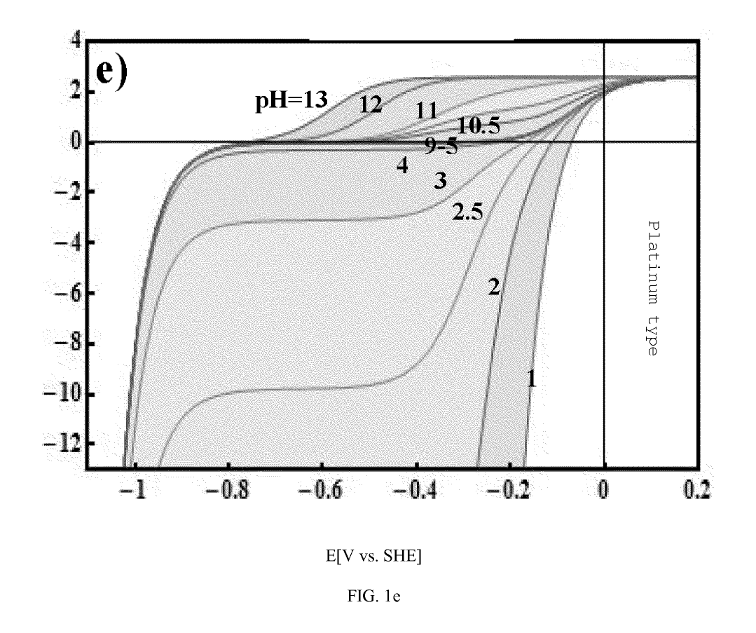

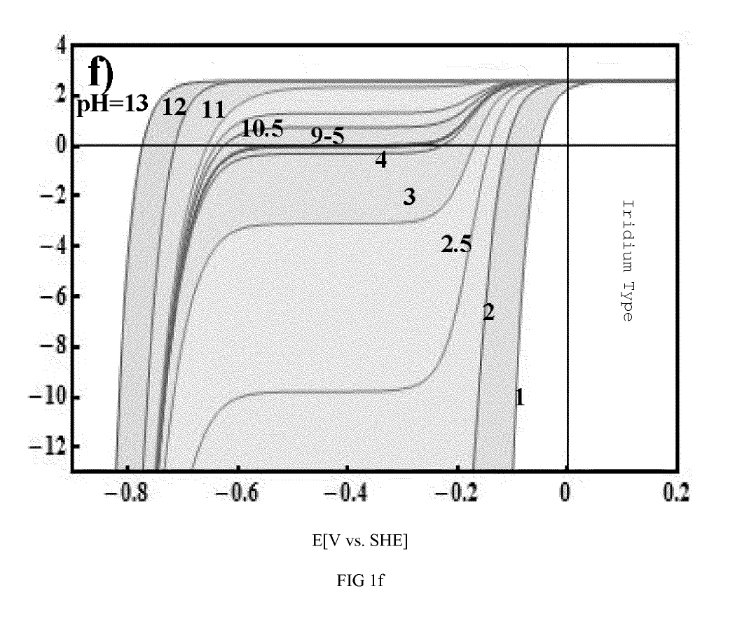

The role of OH⁻ as a reactant in the HOR as demonstrated herein has been overlooked in the art. However, since the source of oxygenated species can also be OH_{ad} (formed via OH⁻⇄OH_{ad}+e⁻), based solely on the results summarized in FIGS. 1a-1f, it would be impossible to unambiguously determine if the reaction requires OH⁻ or OH_{ad}. It is hereinafter demonstrated that OH_{ad} rather than OH⁻ is a key reactant in the HOR in alkaline solutions; and recognition of this feature and its role in catalytic behavior has enabled development of a solution to the problems described hereinbefore. The surface coverage of OH_{ad} (Θ_{OHad}) depends on the bulk concentration of OH⁻. Furthermore, it is well known that both Θ_{OHad} and the nature of OH_{ad} is strongly dependent on both electronic properties of the substrate and the applied electrode potential. It is also well established that OH_{ad} plays a key role in many electrochemical processes; including the oxygen reduction reaction (ORR), oxidation of small organic molecules, oxygen evolution reaction (OER), as well as the HER in alkaline solutions. In the case of the HOR, the prior art has always considered that OH_{ad} is a non-reactive spectator, a species that is blocking the active sites for the adsorption of H₂. While not being limited by any theories expressed herein, this concept may not be accurate; and OH_{ad} can play an important role in the HOR. Unfortunately, given that the current experimental methods are not capable of directly “seeing” OH_{ad}, it is impossible to confirm clearly the existence of this species on any electrode surface. In order to overcome this limitation, the potential dependent surface coverage and energetics of OH_{ad} (and thus its catalytic role) were evaluated by establishing adsorption/catalytic trends that are known to depend on the oxophilicity of the surface atoms. Similarly, the trends in substrate-H₂/H_{ad} energetics also were considered in order to understand how the rate of the HOR may depend on energy of adsorption of hydrogen and formation of reactive intermediates.

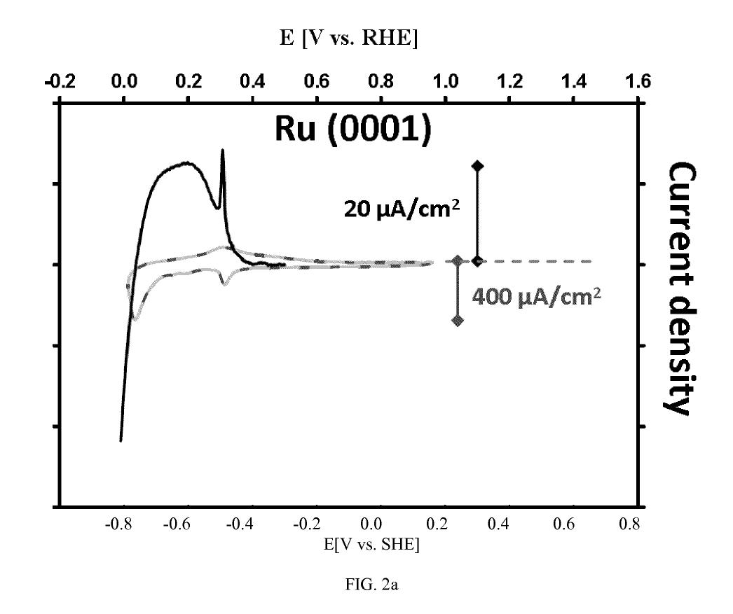

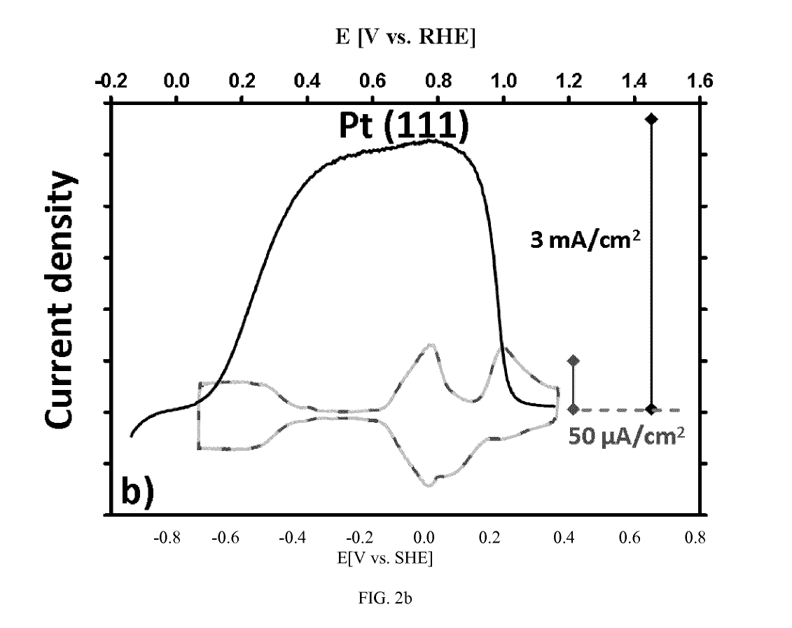

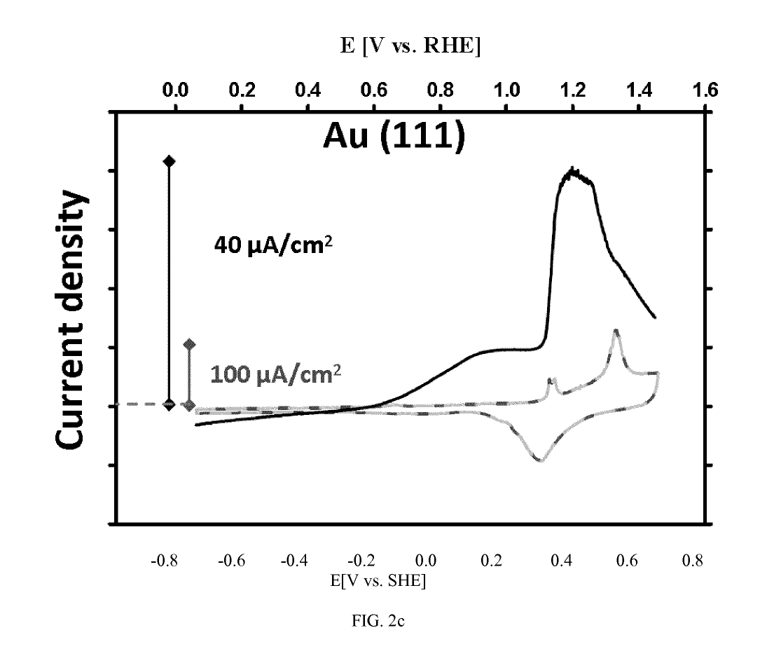

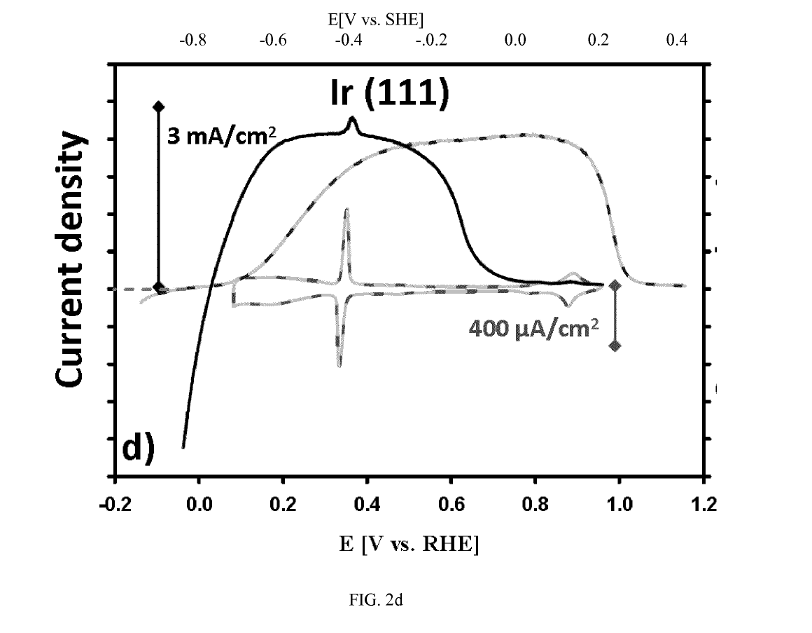

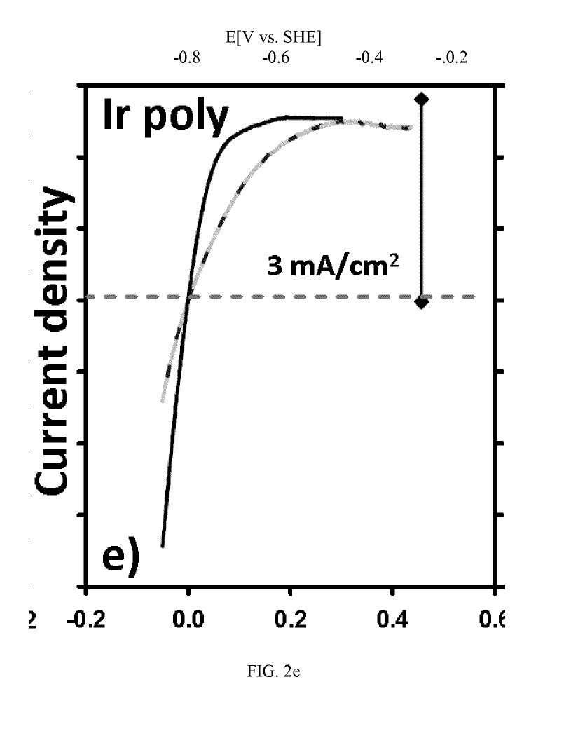

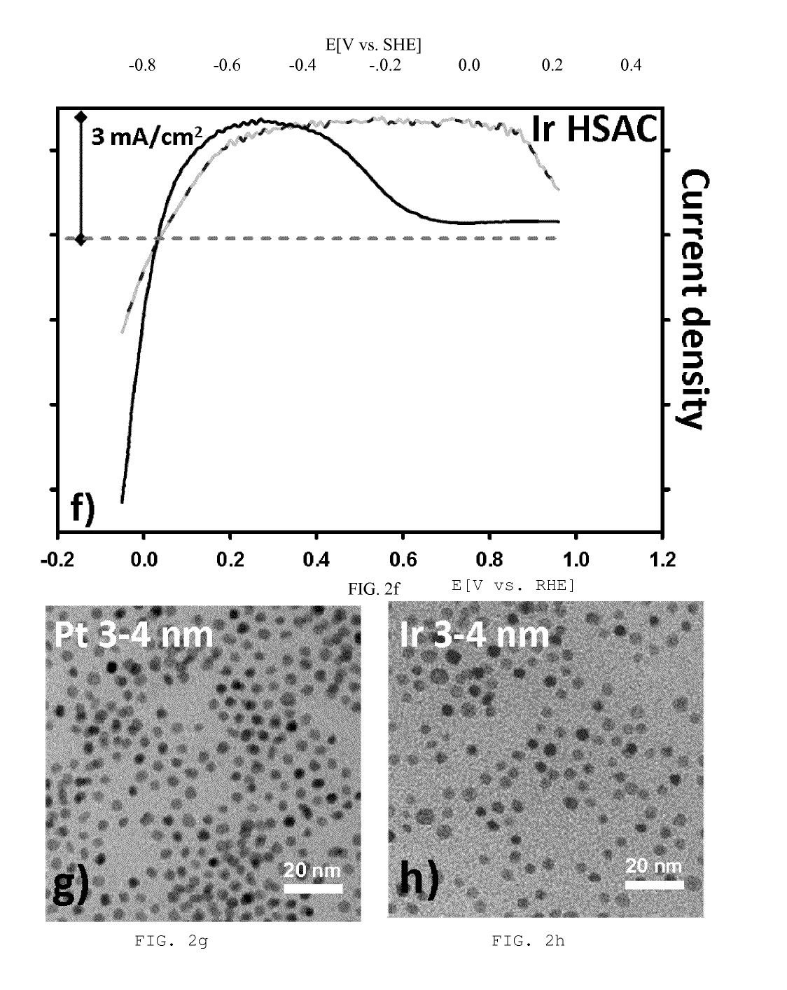

In order to demonstrate the concepts of the instant invention, three metals with completely different affinities for H_{ad} and OH_{ad} were selected as working examples to establish the generic concepts: Au with extremely weak interaction, Ru with a strong interaction, and Pt with neither too weak nor too strong interaction with these adsorbates. In alkaline environments, the expected adsorption trends for these species are clearly observed in cyclic voltammograms as shown in FIGS. 2a-2f. For example, while no adsorption of H_{upd} (defined as hydrogen absorbed at a potential more positive than the reversible potential for the hydrogen reaction) is observed on Au(111), adsorption of OH⁻ visibly occurs only above 1 V vs. the reversible hydrogen electrode (RHE, defined as SHE—60 mV/pH) (see FIG. 2c). However, a close inspection of FIG. 2c reveals a small yet clearly discernible pseudocapacitive feature starting at about 0.6 V; which is believed to be a signature for an initial adsorption of OH⁻, most likely on some defect sites. Very different behavior is observed for Ru(0001) (see FIG. 2a) where the onset of adsorption of oxygenated species is detected at very low potentials (based on CO-displacement experiment, not shown), verifying a strong Ru—OH_{ad} interaction. While not being limited by any theory therein, similar to the results obtained in prior art investigations in acidic electrolyte, the Ru (0001) is believed to be covered mostly by OH_{ad} at potentials close to reversible potential for the hydrogen reaction. In contrast, the CV for Pt (111) (see FIG. 2b) indicates that while between 0.05 to 0.35V the surface is covered by H_{upd}, the OH_{ad} is clearly visible on the surface only above 0.6 V. This behavior is indicative of a weaker Pt—OH_{ad} interaction compared to Ru—OH_{ad} interaction. It was determined there are three different systems with trends in energy of interaction between substrate-OH_{ad}; namely, Au(111)<<Pt(111)<Ru(0001). This trend is also found to be true for substrate-H_{ad} interaction, as has been established using prior art experimental and theoretical observations. As such, these results can serve as a basis for finding variations in the rates of the HOR as a function of the metal-H_{ad} and metal-OH_{ad} bond strength.

For Au(111) in FIG. 2c, the onset of HOR is observed above 0.6 V, which is in agreement with known work. Again not being limited by any theory expressed herein, provided that the HOR follows the formation of OH_{ad}, it is plausible that the HOR is controlled by potential-dependent adsorption of OH_{ad}. Further inspection of FIG. 2c reveals a small “pre-ignition” region beginning at about 0.6V. This is followed first by an ignition-like increase in the oxidation current at 1.1 V and then by a rapid decrease in activity above 1.3 V. Given that the HOR never reaches the diffusion limiting current, it is proposed that above 1.3 V the rate of the HOR is controlled by decrease of the active metal sites (due to formation of oxides) required for the adsorption of H₂. Analysis of a polarization curve for the HOR on Ru (see FIG. 2a) also provides an important insight into the role of OH_{ad} may have on the rate of reaction. The fact that the onset potential of the HOR is observed essentially at zero overpotential strongly suggests that Ru may have very high intrinsic activity for the HOR in alkaline solution. Similar to a Au(111) surface, the maximum oxidation currents are only a few μA/cm²; and as the potential is increased in the positive direction, this current very quickly vanishes to zero (E>0.3 V in FIG. 2a). This could be due to the depletion of active sites for the adsorption/dissociation of H₂ and/or increase in the substrate-OH_{ad} interaction energetics for the Ru (0001) surface. Therefore, while again not being limited by any theory anywhere in this description of the invention, the HOR on Ru in an alkaline solution is believed to be more influenced by the nature and surface coverage of oxygenated species than the Ru—H_{ad} energetics.

As discussed frequently in the prior art, the best catalysts for the HOR are those with an optimal adsorption of hydrogen, which is fulfilled for the Pt—H_{ad} bonding. While this is the case for acidic environments, both the sluggish reaction rates and high structure sensitivity of the HOR in alkaline solutions suggests that the process is not entirely controlled by the Pt—H_{ad} energetics. While again not being limited by theory, in line with the above discussion for Au and Ru, it is proposed that the HOR on Pt(111) must be controlled by both a balance between at least the Pt—H_{ad} and Pt—OH_{ad} energetics. The fact that the oxidation current is observed in the H_{upd} potential region indicates that in alkaline solution OH_{ad} may be present on a surface well below the 0.6 V. It is generally accepted that the active sites for adsorption of OH⁻ on Pt(111) are defects, which are inherently present on every single crystal surface. Given that the order in activity of the HOR on Pt(hkl) surfaces in alkaline solution decreases from highly defected Pt(110) to almost defect free Pt(111) the structure sensitivity in alkaline solutions is believed to be mainly controlled by the structure sensitive adsorption of OH_{ad} on low-coordinated Pt atoms. The number of low-coordinated Pt sites on Pt(111) terraces was either decreased (by utilizing a well-established CO-annealing protocol) or increased (by depositing Pt ad-islands). As expected, while the HOR was strongly inhibited on the former surface, on the latter it was highly activated (see FIG. 1d). Hence we conclude that fine-tuning of adsorption energy of OH_{ad} (while keeping Pt-like adsorption energy of hydrogen) is a new way for designing more efficient anode catalysts that can be utilized in the AFC systems.

One preferred material which establishes these advantageous conditions is Ir, a metal that is known to be more oxophilic than Pt (higher adsorption energy of oxygenated species) but with almost the same adsorption energy of hydrogen. As shown in FIG. 2d, the hydrogen adsorption/desorption on Ir in alkaline solutions is clearly accompanied with OH_{ad} desorption/adsorption, producing a sharp peak centered at 0.375 V. The presence of OH_{ad} was confirmed by utilizing a CO-displacement experiment, which revealed that a negatively charged species is displaced by CO adsorption. In this environment, the only process that can produce negative charge is desorption of OH_{ad} (OH_{ad}=OH⁻+e−). FIG. 2d unambiguously shows that this surface exhibits a 200 mV lower overpotential for HOR than its cousin Pt(111); i.e., a 25-fold increase in catalytic activity at 0.05V. As in the case of the three other single crystal surfaces, the minute amounts of OH_{ad} on Ir(111) below the main OH_{ad} voltammetric feature are more than enough to drive the HOR on these surfaces. In line with the Pt system, it is proposed that the adsorption of active OH_{ad} takes place on defect sites. An increase in activity, albeit slightly less pronounced, is also observed when comparing Pt-poly vs. Ir-poly systems (by a factor 6 at 0.05 V) (see FIG. 2e). As pointed out above, the high activity for the HOR on Ir surfaces in alkaline solutions can explain the observed small variations in the water branch for the HER (see FIG. 1c). More specifically, the overall rate of the HER is partially controlled by contribution of the HOR; as a result, unlike for Au(111), polarization currents reveal some pH-dependence even in the potential region where the HER is controlled by pH-independent processes (see reaction 4 in Example II). Having established the enhancements in the HOR activities in alkaline solutions for the extended surfaces, the same approach can be used to compare Pt (3-4 nm) and Ir (3-4 nm) high surface area catalysts. Once again an enhancement is observed by a factor of 5 at 0.05 V (see FIG. 20, which is an exceptional improvement over current commercial catalysts and can advantageously reduce the precious metal loading on the anode of the AFC by as much as 80%.

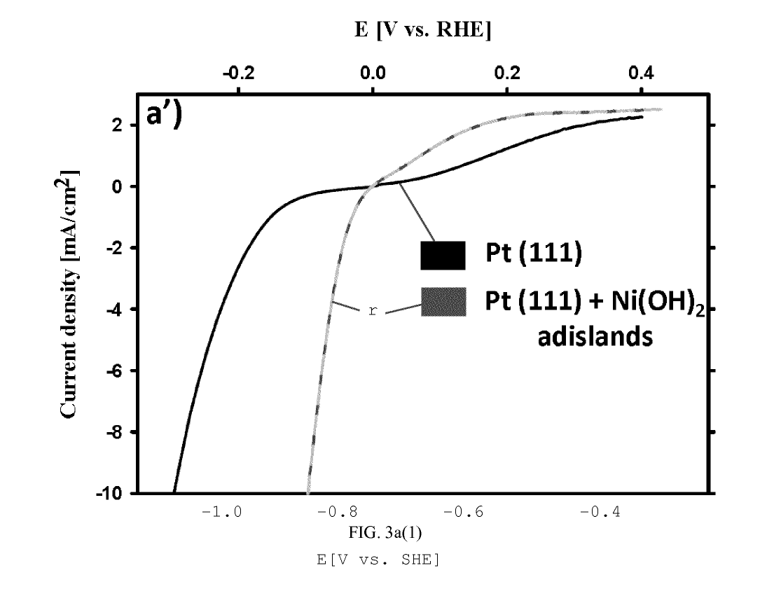

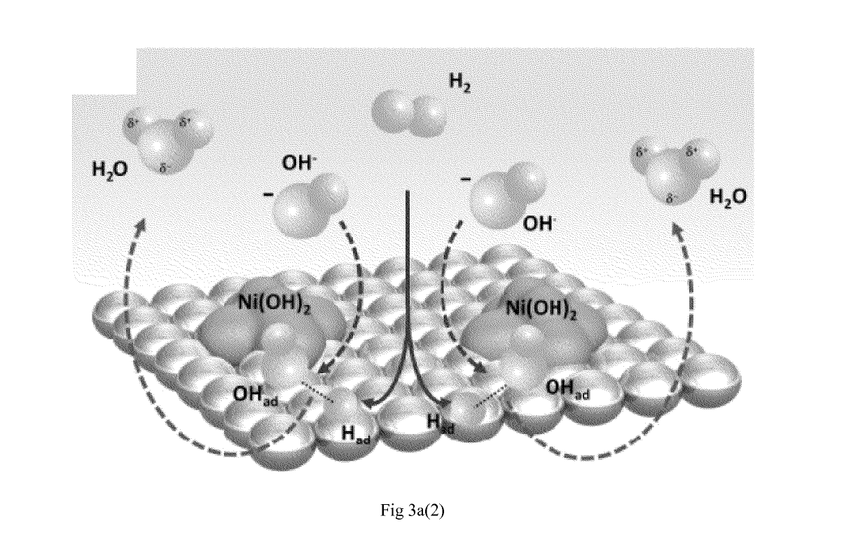

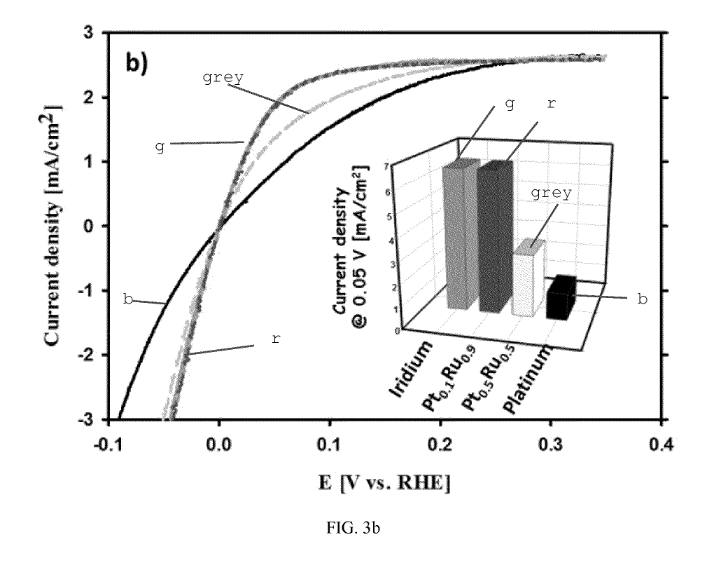

While not limiting the scope of the invention in any way throughout the specification and claims, it has been demonstrated there is a direct link between the fundamental understanding of model electrocatalysts and the development of novel real catalysts in alkaline environments. For monometallic surfaces, it was found that an exemplary highly active material for the HOR in alkaline solution can be Ir (and other such oxophilic metals). This material provides an optimal balance between the active sites required for adsorption/dissociation of H₂ and adsorption of OH_{ad}. To further emphasize the importance of the bi-functional sites for increasing the rate of the HOR in alkaline environments, the power of Pt was combined to activate dissociative adsorption of H₂ and Ni(OH)₂ or Ru to activate adsorption of OH_{ad}. As clearly seen in FIG. 3a(1)-3a(2), Pt(111) decorated with Ni(OH)₂ clusters is more active for the HOR than the bare Pt surface. FIG. 3b shows that this is also true for polycrystalline Pt—Ru alloys, where due to the presence of oxophilic Ru atoms on the surface, the HOR is found to be more facile than on a Pt-poly electrode. For both systems, in a bi-functional effect Ni(OH)₂ or Ru promote OH⁻ adsorption (formation of reactive OH_{ad}) while Pt provides active sites for adsorption of H₂ (formation of H_{ad}). This system offers an opportunity for designing bi-functional catalysts for the HOR in alkaline solutions, wherein both the substrate-H₂/H_{ad} and the substrate-OH_{ad} interaction energies, can be tuned to produce more active, as well as cheaper anode materials for AFCs.

The following non-limiting examples illustrate various aspects of the invention as well as analysis and development of the invention.

### Example I

The role of pH in HER and HOR was measured by experiment and by theoretical simulation. A series of experimentally measured polarization curves are shown in FIGS. 1a-1c and also simulated polarization curves (see FIGS. 1d-1f) for the HER and HOR on Pt(111), Au(111) and Ir-poly in solutions with pH values spanning acidic (pH=1-4), neutral (pH=4-11) as well as the alkaline (pH=11-13) environments. For the HER shown in FIGS. 1a-1c five distinct features are noteworthy. First, at the same pH values, the current-potential curves for Au(111) are shifted towards higher overpotentials (˜0.4-0.8 V) relative to Pt(111) and Ir-poly, arising from the intrinsic differences in the Au—H₂/H_{ad} bond strength. Second, because the rates of the HER/HOR on Pt and Ir are rather fast, at very low pH values we measure mostly the concentration overpotential. Thus, for pH=1-4 any kinetic analysis (reaction mechanism) of the HOR/HER on platinum and iridium is meaningless within ±200 mV (vs. SHE, standard hydrogen electrode). In contrast, due to relatively slower rates in alkaline solutions (pH>11) kinetic analysis might be possible but, for reasons explained later, will not be considered here. Third, in solutions with pH<4, pure diffusion limiting currents are observed at higher overpotentials (−1.5<E<−0.8 V for Au; −0.9<E<−0.4 V for Pt and −0.7<E<−0.2 V for Ir), implying that under these experimental conditions the HER on all three surfaces is controlled by the mass transport of reactive species (H₃O⁺) rather than the charge transfer reaction. Similar experimental results have been observed in the prior art on a Pt-poly electrode. Fourth, within the same potential regions, very small (order of μA/cm²) currents are observed in solutions with higher pH values (pH>5). Finally, an additional reduction process is observed at potentials negative of −1.5 V, −0.9 V and −0.7 V for Au, Pt and Ir, respectively. While a complete pH independence of the measured currents is observed for Au(111) systems above pH=5, Pt(111) and Ir-poly do exhibit discernible pH dependence; this is especially true in the case of Ir. As discussed in Example II, the reason for this arises from the contributions of the HOR to the measured HER rates. It is also important to note that irrespective of the material type (Au vs. Pt vs. Ir), or the surface structure of the electrodes (single crystal vs. polycrystalline), the qualitative behavior of the HER, as a function of pH, on these materials is nearly identical.

The observed pH variations were analyzed in the HOR on Pt(111), Au(111) and Ir-poly surfaces (FIGS. 1a-1c). In line with earlier prior art observations, Au(111) shows no measurable currents for the HOR in the range of potentials considered here. On the other hand, even though there are quantitatively different reaction trends for the HOR between Ir and Pt (111) (as we discuss later), the qualitative trends are nearly identical. In particular, pure diffusion limited currents are observed for pH=13-11, suggesting that the reaction is controlled by mass transport of reactants required for the electrochemical conversion of H₂ to water. In the narrow pH range 9.5-11, however, two diffusion limited plateaus are clearly visible (decreasing in magnitude with decreasing pH) indicating that the overall current is influenced by two separate processes. Finally, FIGS. 1b and 1c show that for pH<9 the reaction rate is strongly dependent on the applied potential; while below −0.2V negligible currents are observed, above −0.2 V the total rate of the reaction is controlled by a pure mass transport of H₂.

### Example II

As described in Example I, in order to obtain insight into the pH-dependent processes that are controlling the polarization curves in FIGS. 1a-1c, a simulation was performed of experimental results as a means of describing how the variations in bulk and near-surface concentrations of both pH-dependent ([H⁺] and [OH⁻]) as well as pH-independent ([H₂] and [H₂O]) components may influence the total current density (i+j) using a simple set of equations. This is given as the sum of four processes described by Equations. 1-4:

H₂+2H₂O→2H₃O⁺+2e⁻ (1)

H₂+2OH⁻→2H₂O+2e⁻ (2)

2H₃O⁺+2e⁻→H₂+2H₂O (3)

2H₂O+2e⁻→H₂+2OH⁻ (4)

$$\begin{matrix}i = 2 {{{FK}_{1} [ {H}_{2} ]}_{x = 0} [ {OH}^{-} ]}_{x = 0} {e}^{( 1 - {α}_{1} ) ( \frac{F}{RT} ( E - {E}_{1}^{0} ) - ln [ {H}_{2} E )} - 2 {{FK}_{1} [ {H}_{2} O ]}_{x = 0} {e}^{- {α}_{1} ( \frac{F}{RT} ( E - {E}_{1}^{0} ) - {ln [ {H}_{2} ]}^{\frac{1}{2}}} & ( 5 ) \\ j = 2 {{FK}_{2} [ {H}_{2} ]}_{x = 0} {e}^{( 1 - {α}_{2} ) ( \frac{F}{RT} ( E - {E}_{2}^{0} ) - ln [ {H}_{2} E )} - 2 {{FK}_{2} [ {H}_{3} {O}^{+} ]}_{x = 0} {e}^{- {α}_{2} ( \frac{F}{RT} ( E - {E}_{2}^{0} ) - {ln [ {H}_{2} ]}^{\frac{1}{2}}} & ( 6 )\end{matrix}$$

where i and j represent current densities for reactions (2)&(4) and (1)&(3), respectively, F is the Faraday constant and [H₂]ₓ₌₀, [OH⁻]ₓ₌₀, [H₃O⁺]ₓ₌₀, and [H₂O]ₓ₌₀ are activities/concentrations of the reactants at the electrode surface (x=0). In our treatment of the current density vs. potential relationship, coverages of intermediates (H_{ad}/OH_{ad}) as well as spectators have been lumped into the rate constants (K₁₋₂) which are effective rate constants for the four elementary steps; i.e., they are not intrinsic rate constants. E₁⁰ and E₂⁰ are standard potentials for reaction pairs (2)&(4) and (1)&(3), respectively, α is the transfer coefficient, R is the standard gas constant and T is the temperature in K. Note that since all the experiments were performed at partial pressure of hydrogen of 1 atm, the ln [H₂]^{1/2} term was omitted from Equations (5) and (6) in our simulation (for further details see supplemental information). In the following, values of K₁₋₂ were estimated from the experimentally observed differences in activity of a particular surface (see FIGS. 1a-1f). Finally, mass transfer effects are introduced in overall kinetic rates using Equation (7):

$$i , j = 0.62 nFA {ω}^{\frac{1}{2}} {v}^{- \frac{1}{6}} {D}_{1 - 4}^{\frac{2}{3}} ( {[ {C}_{1 - 4} ]}^{*} - {[ {C}_{1 - 4} ]}_{x = 0} ) \qquad ( 7 )$$

where ω is the rotation rate, v is dynamic viscosity, D₁₋₄ are diffusion coefficients of the reactants in Equations (1) to (4) and [C₁₋₄]* and [C₁₋₄]ₓ₌₀ are the bulk and surface activities of reactants in Equations (1) to (4), respectively.

To test the validity of this method, the HER reactions were first examined under different pH values. As shown in FIGS. 1d-1f, the HER currents, observed for pH<2 were found to be primarily determined by reaction (3). Also, the simulation effectively captures the diffusion limiting currents for the HER reaction in the pH range of 2.5<pH<4.0; via reaction (3), the values of diffusion limited currents are determined by proton concentration. In agreement with experimental results, at higher pH values (pH>9), the HER currents are mainly controlled by reaction (4), signifying the experimentally observed existence of a pH independent branch. Based on the foregoing, both experiment and simulations confirm the existence of two clearly distinguishable branches in the HER: a pH-dependent “proton branch” and a pH-independent “water branch”, the latter being governed by a relatively slow charge-transfer induced water dissociation step. Having established the effectiveness of the reaction set considered here to mimic the HER branches, we then simulate the polarization curves to determine what governs the intrinsic pH-differences in the HOR on the Au(111), Pt(111), and Ir-poly systems. Given the weak energetics for Au—H₂ interaction (very low K value), the rate of the HOR in both acid (reaction 1), and alkaline (reaction 4), environments is found to be negligible. In turn, the contribution of the oxidation currents to the reduction currents (reactions 3 and 4), on Au is negligible. As expected, Pt and Ir behave differently; i.e, in acidic environments (below pH=3), our simulated curves reveal that the HOR proceeds via the direct (pH independent) oxidation of H₂ to protons, reaction (1). In strong alkaline environments (pH=13-11) pure diffusion limiting currents are observed, suggesting that reactant supply (in our simulations H₂ and OH⁻) is sufficient to maximize the electrochemical rate of H₂ conversion to water. FIGS. 1a and 1d show that a decrease in the diffusion limiting currents is observed between pH=11-9.5, correlating well with the decrease in availability of OH⁻ ions. Finally, for pH<9.5 diffusion limiting currents for reaction (2) are not observed, signaling that the concentration of OH⁻ is so small that the measured currents are (as in the case of the proton branch) again in the “invisible” (μA) range. Nevertheless, the HOR still proceeds through reaction (1) at potentials positive of −0.2 V. Clearly, then, this provides a first strong indication that OH⁻ indeed plays an important role in the HOR, and even an overlooked detail in the alkaline HOR analysis.

### Example III

### High k—Fast Kinetics (Iridium Poly Case) K_{1,2}=1

Starting with pH=0, by definition the polarization curve intersects the abscissa at SHE=0V. The redox pair determining this potential is H₃O⁺/H₂. The currents for processes 1 and 3 (see Example II) at SHE=0 are the same and equal the exchange current i₀. For clarity, the pH values of 0 and 14 are omitted and the pH scale starts at 1 so the first curve intersects i=0 at −60 mV.

At lower pH values 0-3, the reaction 2 is expected to be completely suppressed due to the low concentration of OH⁻ ions. The polarization curve is composed of currents for reactions 1, 3 and 4 (again see Example II). The latter can only be observed at very negative potentials (<−0.8) due to the low K₁ value, i.e. high overpotential for splitting of the water molecule. The polarization curve at more positive potentials for these pH values is governed completely by processes 1 and 3. Although the current response of the reaction 1 does not change with pH, current i_{K3} is reduced by 10 times per pH increase by 1. The sum of these two currents, which is the observed polarization curve, therefore exhibits a shift of 60 mV/pH corresponding to the concentration overpotential.

$$\frac{E - {E}_{eq} = η = \frac{RT}{F} ln ( {{[ {H}_{3} {O}^{+} ]}_{x = 0} [ {H}_{2} ]}^{*} )}{{{[ {H}_{3} {O}^{-} ]}^{*} [ {H}_{2} ]}_{x = 0}}$$

This also confirms that assumptions about the reaction mechanism do not significantly alter the prediction capability of the model, as no direct mechanistic parameter is involved in the equation describing the current-voltage behavior for this set of pH and K values.

As the pH is increased to 3-4, reaction 3 runs into mass transport control due to the lack of excess amount of protons. The diffusion limiting current of the reaction 3 becomes lower and lower as the pH is increased. At pH 5, process 3 no longer contributes to the overall current due to insignificant proton concentration. As a result, the polarization curve is essentially the sum of the currents for reactions 1 and 4. Due to the large differences in overpotentials, these two processes are completely separated and can be studied as such. Moreover, both of these reactions are pH independent and it is therefore no coincidence that the polarization curve almost does not change in pH range from ca. 4-10. At pH=10, the concentration of OH⁻ is high enough that one observes the current for reaction 2. The current for this process is still diffusion limited up to pH 11; and two diffusion limited plateaus are noted. At lower potentials, the oxidation current is governed by mass transport of Off to the surface and at higher potentials by the mass transport of H₂ to the surface. The polarization curve at pH 10-11 consist of currents representing processes 1, 2 and 4.

Finally, at pH values higher than 11, OH⁻ mass transfer is no longer a limiting step in the hydrogen oxidation via reaction 2. The observed diffusion limiting current is solely due to mass transfer of hydrogen to the surface. Since all hydrogen is consumed via reaction 2 at low potentials, reaction 1 is completely masked and cannot be resolved from the observed polarization curve. Processes 2 and 4 determine the shape of the polarization curve at these high pH values. Similar to pH 0-3, a shift of the polarization curve by 60 mV/pH is observed corresponding to the concentration overpotential. Same argument as above can be made here. Although current for process 4 is unaltered by pH changes, the pH dependency of reaction 2 causes the shift of the sum polarization curve.

### Low k Values—Very Slow Kinetics (Au (111) Case), K₁=10⁻⁹, K₂=10⁻⁶ with Ks for Anodic Reactions Set to 0

In this instance the hydrogen oxidation current is not observed for either reaction 1 or 2. This explains the reason for no observable curve shifts at pH values above 11. The prior art mistakenly has distinguished between metals with pH dependent HER at high pH values and metals with no dependence. In fact as per reaction 4, HER is always pH independent at high pH values. It is the rate of reaction 2 that gives an apparent dependence. Moreover, due to the sluggish kinetics of reaction 3, the curve shifts at lower pH values (0-3) no longer correspond to diffusion overpotential of 60 mV, but rather to 120 mV which is related to the rate determining step. As mentioned above, the anodic currents were set to 0 in the simulated curves for Au (111). FIG. 1d represents the outcome of simulation with K₁=10⁻⁹, K₂=10⁻⁶. As can be seen, the simulation predicts the appearance of oxidation currents at about −0.2 V SHE translated to cca. 0.6 RHE at pH=13. Incidentally, this is the same potential where we see the onset of HOR in FIG. 2c. Those currents however are very small due to the availability of surface sites for the reaction (1−θ_{spectators}) which is not included in the simulation. To avoid this discussion in the main text, the rate constants for reactions (1) and (2) were set to 0 for the simulation in FIGS. 1a-1f.

### Medium k Values—Slower Kinetics (Pt (111) Case) K₁=10⁻⁴, K₂=10⁻³

Most arguments made for the fast and very slow kinetics case still hold true. This is the case in between the two. The curve shifts at low pH values are between 60 and 120 mV and closer to 0 at high pH values. Processes 1 and 4 are not completely separated in pH region 4-10. Instead that range narrows to 5-9. For the case of OH adsorption on Au (111), see FIG. 4.

In experiments with Pt single crystals in alkaline environments the pre-history of the electrode is important in determining adsorption and catalytic properties. For example, FIG. 5 shows that after potential cycling the activity of the HOR on Pt(100) is attenuate relative to the pristine electrode. This deactivation may arise due to a combination of morphological changes (disappearance of active Pt ad-islands) and contamination of Pt surface sites with impurities that are inherently present on in alkaline solutions. Nevertheless, FIG. 5 shows that while the as prepared Pt(100) surface is more active than Pt (111), the cycled surface is less active than Pt (111).

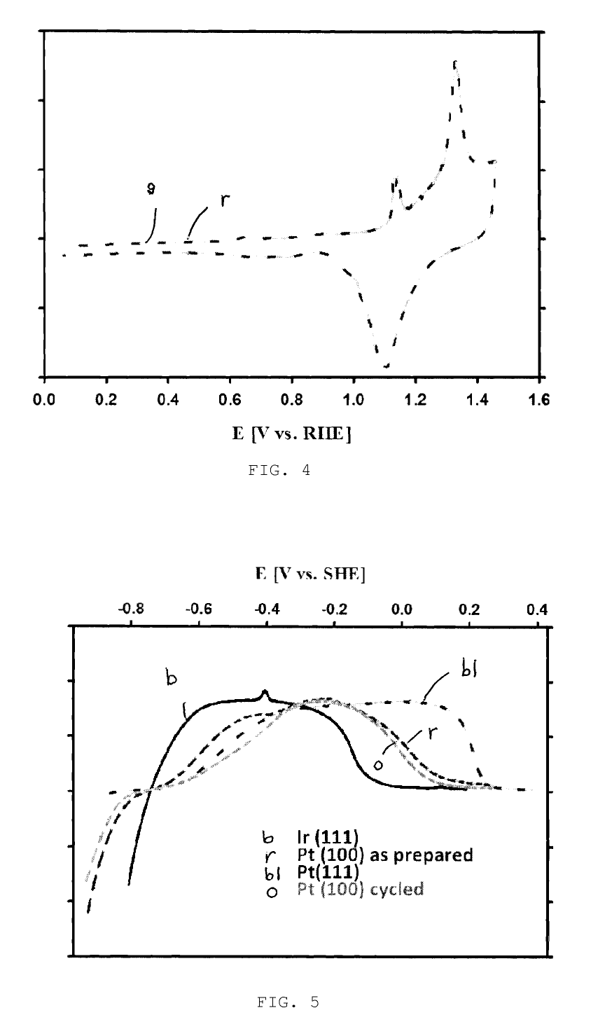

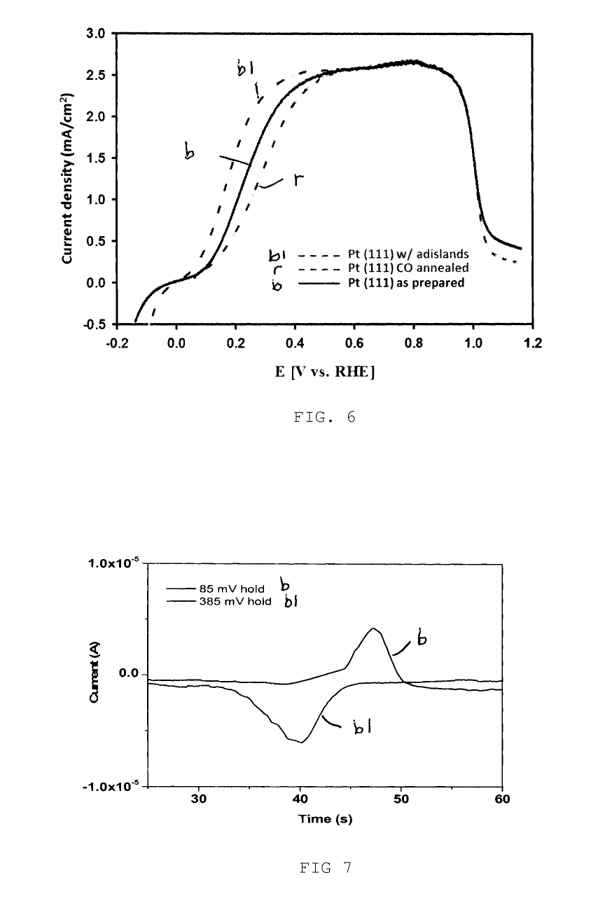

In order to probe the role of ad-islands on the observed HOR as well as HER rates, FIG. 6 illustrates a comparison in HOR activities for Pt(111), prepared from RF annealing, and a Pt(111) surface modified by Pt-ad-islands. The presence of more oxo-philic ad-islands acts as a favorable site for adsorption of the OH_{ad} species. As a result, the oxidation of hydrogen molecules is promoted on these surfaces. This is similar to the behavior exhibited by higher order Pt surfaces such as Pt(100) and Pt(110) which are also known to consist of a large number of such low co-ordinated Pt ad-islands. This lends further credence to the hypothesis, that the HOR in alkaline solution requires the presence of adsorbed OH species in order for the reaction to proceed. In contrast, as the surface is CO annealed, which is known to get rid of these defects from the surface, then the activity for the Pt(111) surface is even lower further confirming the beneficial effect of the oxo-philic sites. In the case of CO displacement on Ir (111), see FIG. 7.

### Example IV

Extended surface electrode preparation was performed as follows. Pt(111), Ir(111), Au(111), Pt-poly and Ir-poly electrodes were prepared by inductive heating for 5 minutes at ˜1050° C. for Pt, ˜800° C. for Au and 1200° C. for Ir electrodes in an argon hydrogen flow (3% hydrogen). Ru (0001) sample was prepared by sputtering and annealing in UHV. The annealed specimens were cooled slowly to room temperature under an inert atmosphere and immediately covered with a droplet of DI water. Electrodes were then assembled into a rotating disk electrode (RDE). Voltammograms were recorded in argon saturated electrolytes. Polarization curves were recorded in hydrogen saturated electrolyte.

For the synthesis of Ir nanoparticles, iridium acetylacetonate was reduced by 1,2-tetradecanediol in a benzyl ether solution at 290° C., with oleylamine and oleic acid as stabilizing ligands. For the synthesis of Pt nanoparticles, platinum acetylacetonate was reduced by borane tributylamine at 120° C. in an oleylamine solution. These nanoparticles were transferred onto the glassy carbon disk and the organic surfactants were removed by thermal treatment (185° C.) in air.

Solutions of different pH values were prepared by adding 0.1 M KOH or 0.1 M HClO₄ to 0.1 M KClO₄ solution. All chemicals used in our experiments were obtained in the highest purity from Sigma Aldrich. Electrolytes were prepared with Millipore Milli-Q water. All gases (argon, oxygen, hydrogen) were of 5N5 quality purchased from Airgas Inc.

A typical three electrode FEP cell was used to avoid contamination from glass components. Experiments were controlled using an Autolab PGSTAT 302N potentiostat. The crystal electrodes, embedded into the RDE assembly, were transferred into a standard three-compartment electrochemical cell where the voltammograms and/or polarization curves were recorded. The nanocatalysts supported on GC were measured in hanging meniscus configuration. All reported polarization curves and voltammograms are first cycle measurements as to limit the effects of possible contamination from the electrolyte.

However, since this invention provides HOR/alkaline catalysts with 20+ times the activity using a fraction of the platinum ( 1/10 with rest being Ru at $14/gram pure for example) previously required, this means that material cost for the same activity drops by a factor of greater than 100 (20 divided by ⅕). These bifunctional catalyst materials can be synthesized at nano scale to maximize surface area. Anodes can be prepared potentially cheaper than using nickel catalyst; but more importantly if anode activity is the rate-limiting step in the commercial AFC's, this new invention could allow the anodes to shrink determined by the next rate limiting step (probably the ion transport membrane). This reduces the size (and materials used) of the entire AFC system, making it much more competitive with alternative fuel cell technologies. Consequently, even cheaper and more active bifunctional HOR/alkaline catalysts could be designed, further extending potential cost/performance advantages.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments, and with various modifications, as are suited to the particular use contemplated.

What is claimed is:

1. A method of improving hydrogen oxidation rate in a catalyst for use in AFCs comprising the steps of,
providing a catalyst substrate;
disposing on the catalyst substrate a material having balanced active sites for adsorption/dissociation of H₂ and adsorption of OH_{ad}, thereby enhancing the hydrogen oxidation rate for use in AFCs.

2. The method as defined in claim 1 wherein the material comprises a catalytic material.

3. The method as defined in claim 2 wherein the catalytic metal comprises a Pt based alloy.

4. The method as defined in claim 2 wherein the catalytic metal is selected from the group of Ir, Pt—Ru alloys and Pt combined with transition metal hydroxide ad-islands.

5. The method as defined in claim 4 wherein the transition metal hydroxide comprises Ni(OH)₂.

6. The method as defined in claim 4 including the step of forming additional catalytically active defect sites on the catalytic metal, thereby further enhancing catalytic activity.

7. The method as defined in claim 1 wherein providing the balanced active sites includes the step of adding oxophyllic sites.

8. The method as defined in claim 1 further including the step of disposing the catalyst on a fuel cell electrode.

9. The method as defined in claim 1 further including the step of subjecting the material to an annealing step to modify surface composition.

10. A catalytic article of manufacture, comprising:
a substrate for a catalyst; and
a coating disposed on the substrate wherein the coating comprises an oxophyllic material having a set of active sites providing a balanced adsorption/dissociation for H₂ and adsorption of OH_{ad}, thereby enhancing the hydrogen oxidation rate.

11. The article of manufacture as defined in claim 10 wherein the oxophyllic material is selected from the group of a Pt alloy, Ir and Pt with transition metal hydroxide ad-islands.

12. The article of manufacture as defined in claim 10 wherein the oxophyllic material comprises a catalytic noble metal alloyed with Ru.

13. The article of manufacture as defined in claim 10 wherein the oxophyllic material comprises a nano based material.

14. The article of manufacture as defined in claim 10 wherein the oxophyllic material comprises a nano based metal having a greater oxophyllic activity than Pt with a stronger interaction with OH_{ad} but about a same binding energy with H_{ad}.

15. The article of manufacture as defined in claim 10 wherein the oxophyllic material comprises a bimetallic material providing simultaneously active sites for dissociation/adsorption of H₂ and adsorption of OH_{ad}.

16. The article of manufacture as defined in claim 15 wherein the bimetallic material comprises transition metal hydroxide ad-islands.

17. The article of manufacture as defined in claim 16 wherein the transition metal comprises a d-block metal.

18. The article of manufacture as defined in claim 10 wherein the substrate comprises an AFC anode.

19. The article of manufacture as defined in claim 10 wherein the oxophyllic material is selected from the group of a catalytic noble metal.

20. The article of manufacture as defined in claim 19 wherein the catalytic noble metal is selected from the group of Ru, Rh, Pd, Re, Os, Ir and Pt.
